(19) United States
(12) Patent Application Publication
(10) Pub. No.: US 2011/0278316 A1
(43) Pub. Date: Nov. 17, 2011

(54) Protective Cap for Tank

(76) Inventors: Bernardo Herzer, Los Angeles, CA (US); David Kostka, Los Angeles, CA (US); Shmuel D. Newman, Redondo Beach, CA (US)

(21) Appl. No.: 13/104,954

(22) Filed: May 10, 2011

Related U.S. Application Data
(60) Provisional application No. 61/333,255, filed on May 11, 2010.

(51) Int. Cl. F17C 13/06

(52) U.S. Cl. 220/727; 220/724; 137/382

(57) ABSTRACT

A protective cap for a tank, such as a LPG tank, with a valve normally at the top. The protective cap covers the top of the tank in a fashion to protect the valve. The protective cap may have ribs that enable for stacking of the tanks on top of one another. The ribs also allow for easier handling, such as hooking onto. The protective cap may also have a protrusion to provide a secondary seal to the main service valve of the tank.

This patent application claims the benefit of, priority of, and incorporates by reference U.S. Provisional Patent Application Ser. No. 61/333,255, entitled “Protective Cap for LPG Tank” by Bernardo Herzer, David Kostka, and Shmuel D. Newman filed on May 11, 2010.

### BACKGROUND OF THE INVENTION

1. Field of the Invention

This invention relates to a cap for a tank. In particular it pertains to a protective cap for a tank or container with a valve device.

2. Description of the Related Art

Typical LPG or propane storage tanks, bottles, containers or cylinders (referred to as tanks here forth) have a valve device on the top or head of the tank which could be vulnerable to damage if dropped or falling over. An impact on the valve that is sufficient to break the valve off of its threaded attachment to the tank can lead to a very dangerous accident. For this reason, tanks are required to have some protection around the valve. Typical 4-40 lb propane tanks which are portable for gas grills and the like have a welded metal ring surrounding the valve for protection.

Smaller 1 lb or less propane tanks such as used for camping equipment and torches do not use such a protective device, primarily due to weight reasons because they are used for hand held devices. Currently small, approximately 1 lb. propane tanks only have a thin plastic disposable cap which protects the threads of the valve but does nothing to prevent damage to the valve's attachment to the tank should it be dropped or knocked over.

### BRIEF SUMMARY OF THE INVENTION

Typical small LPG tanks and bottles have a valve at the top, where this valve is generally exposed and not protected. Herein is disclosed a cap which protects the valve and its attachment to a tank or bottle. This protective cap may also have useful carrying handles which may be used to attach a clip or hook to carry it with camping gear. Its design is ideally designed to be lightweight, convenient to use, and reusable.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a perspective view of an embodiment of the protective cap and a typical tank it is designed to protect.

FIG. 2 is a perspective view of an embodiment of the protective cap on a LPG bottle or tank.

FIG. 3a is a top view of an embodiment of the protective cap installed on a tank.

FIG. 3b is a cross sectional view through an embodiment of the protective cap installed on the tank along the axis G-G as shown in FIG. 3a.

FIG. 4 is a cross sectional view through another embodiment of the protective cap installed on the tank along the axis G-G as shown in FIG. 3a.

### DETAILED DESCRIPTION

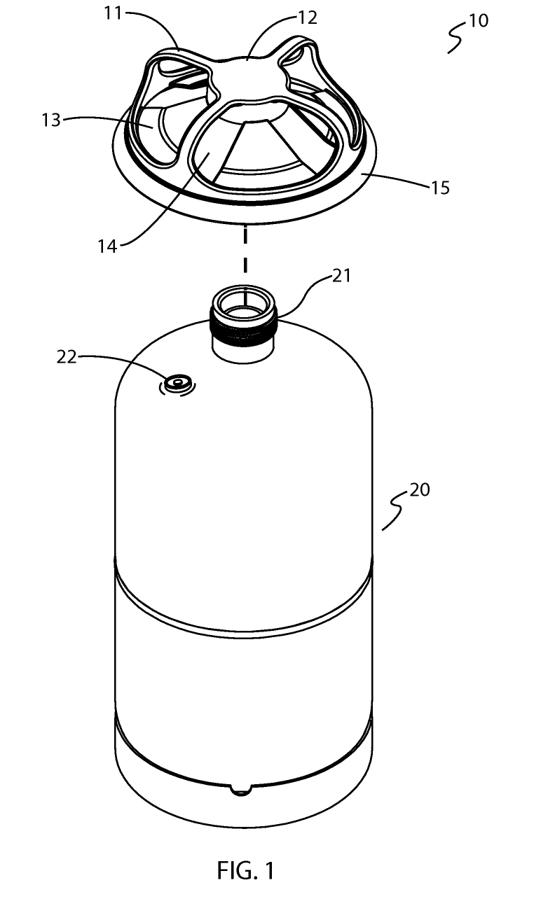

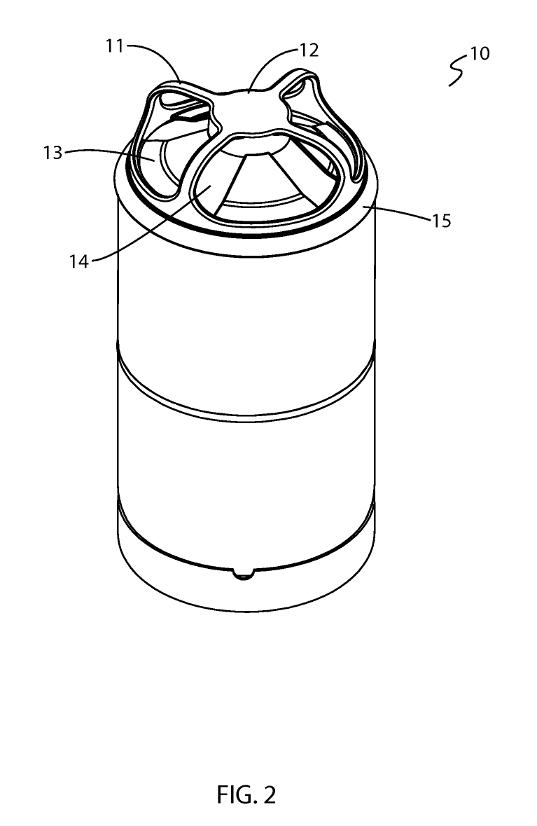

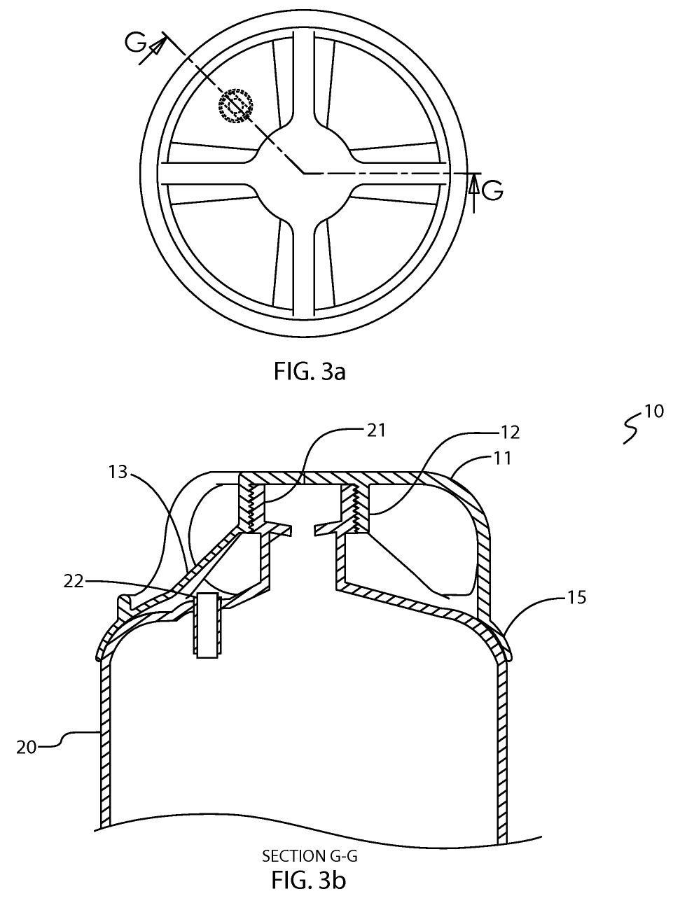

The protective cap described here is preferred to be made of an injection moldable plastic, although other materials could be used. FIG. 1 shows a preferred embodiment of the protective cap. The cap 10 installs onto the valve 21 by threading it onto the valve's threads, but it could also snap over the threads. It may also snap over the depression at the base of the valve. As depicted in FIG. 2, the shape of the preferred embodiment of the cap incorporates a surface 15 which extends onto the top surface of the tank or cylinder 20, and conforms to the shape of the cylinder so as to distribute the load from an impact to the broad upper surface of the tank should the tank be dropped or knocked over. Ribs 11 incorporated into the cap extend from the valve protecting portion of the cap 12 onto the larger diameter bottle conforming surface 15, thus further protecting the valve and shielding it from any direct impact from a hard edged surface. The same ribs 11 may also open on their undersides, so that they form an opening that is sized and shaped so as to be useful and comfortable to use as a handle by inserting one's finger under the arch. The arch is also sufficiently strong so that it can be clipped onto camping gear or the like for carrying or transporting the full weight of the full tank. Another aspect of the design is that the ribs 11 extend from the top surface of the valve protecting portion of the cap 12 so as to remain flat which does not add additional height to the tank, and creates a flat shape which is stackable, thus maximizing bulk packaging. Another feature of an embodiment of the cap is that it has open areas 14 between the lower supporting ribs 13 which allow the safety pressure relief valve 22 on the tank to flow un-obstructed should the pressure rise so high in the tank as to make said pressure relief valve open. In case a lower supporting rib should cover the safety pressure relief valve 22, enough clearance exists between the underside surface of the lower supporting ribs 13 and the upper surface of pressure relief valve 22 that the flow of gas from the pressure relief valve 22 is generally unobstructed.

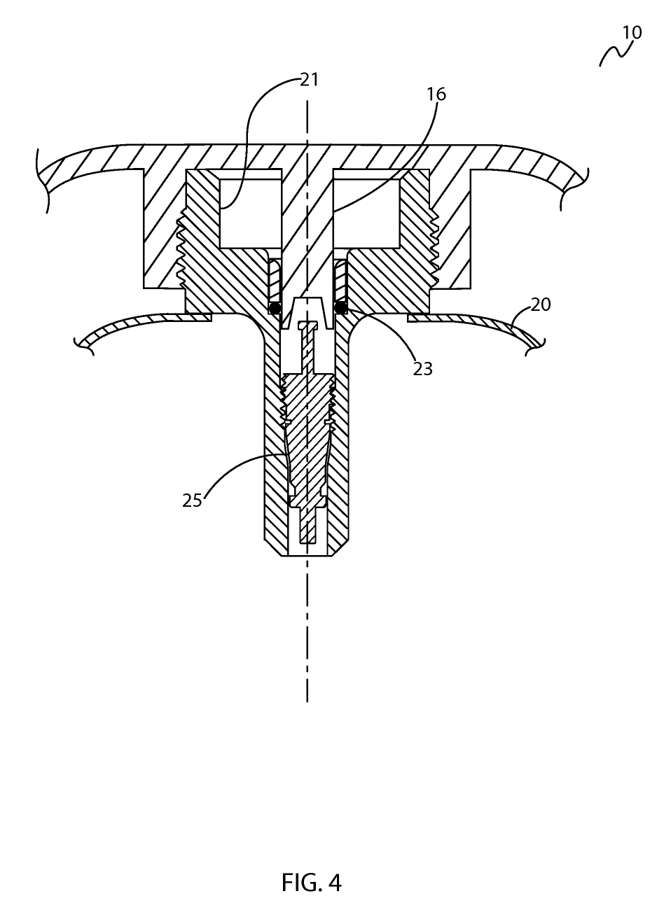

Additionally, as depicted in FIG. 4, an embodiment of the cap may be capable of performing a secondary seal with the outlet of the main service valve 25, such that if the tank's main service valve leaked, the cap would seal the tank and prevent dangerous accidental discharge of the flammable gas. This is accomplished by incorporating a protuberance 16 on the inside of the cap which seals against the O-Ring 23 in the valve 21 when the cap is fully installed. The length of protuberance 16 is long enough to fully engage the seal 23, but not so long as to depress and activate the service valve 25. This feature provides an extra margin of safety as well as protecting the main service valve from the ingress of dirt and moisture.

The present invention has been described in an illustrative manner. It is to be understood that the terminology which has been used is intended to be in the nature of words of description rather than of limitation. While there have been described herein, what are considered to be preferred and exemplary embodiments of the present invention, other modifications of the invention shall be apparent to those skilled in the art from the teachings herein and, it is, therefore, desired to be secured in the appended claims all such modifications as fall within the true spirit and scope of the invention.

What is claimed is:

1. A protective cap for a tank comprising:
a valve protecting portion attaching to a service valve of said tank;
a bottle conforming surface; and
a plurality of ribs interconnected from flush top of said valve protecting portion to said bottle conforming surface.

2. The protective cap of claim 1 wherein said attaching is by threading onto said service valve of said tank.

3. The protective cap of claim 1 wherein said attaching is by snapping onto said service valve of said tank.

4. The protective cap of claim 1 wherein said plurality of ribs are open on the undersides and form an arch sufficient to be hooked by an average finger.

5. The protective cap of claim 4 wherein said plurality of ribs extend from flush top of said valve protecting portion as to remain flat with the top surface of said valve protecting portion sufficiently long enough before arching to create a stackable surface for said tank.

6. The protective cap of claim 1 further comprising a plurality of lower supporting ribs interconnected from said valve protecting portion to said bottle conforming surface.

7. The protective cap of claim 6 wherein said plurality of lower supporting ribs provides clearance between an underside surface of said lower supporting ribs and a pressure relief valve of said tank as to generally allow for the unobstructed flow of gas from said pressure relief valve.

8. The protective cap of claim 1 further comprising of a protuberance on the underside of said valve protecting portion seals with an O-ring of said tank's service valve and does not depress and activate said tank's service valve, whereby forming a secondary seal and providing added safety to said tank.

9. A protective cap for a tank comprising:
a valve protecting portion attaching to a service valve of said tank;
a bottle conforming surface;
a plurality of ribs interconnected from flush top of said valve protecting portion to said bottle conforming surface;
a plurality of lower supporting ribs interconnected from said valve protecting portion to said bottle conforming surface; and
a protuberance on the underside of said valve protecting portion seals with an O-ring of said tank's service valve and does not depress and activate said tank's service valve, whereby forming a secondary seal and providing added safety to said tank.

10. The protective cap of claim 9 wherein said plurality of ribs are open on the undersides and form an arch sufficient to be hooked by an average finger.

11. The protective cap of claim 10 wherein said plurality of ribs extend from flush top of said valve protecting portion as to remain flat with the top surface of said valve protecting portion sufficiently long enough before arching to create a stackable surface for said tank.

12. The protective cap of claim 11 wherein said plurality of lower supporting ribs provides clearance between an underside surface of said lower supporting ribs and a pressure relief valve of said tank as to generally allow for the unobstructed flow of gas from said pressure relief valve.

13. The protective cap of claim 12 wherein said attaching is by threading onto said service valve of said tank.

14. The protective cap of claim 12 wherein said attaching is by snapping onto said service valve of said tank.
